(19) United States
(12) Patent Application Publication
(10) Pub. No.: US 2009/0284794 A1
(43) Pub. Date: Nov. 19, 2009

(54) DOCUMENT PROCESSOR, IMAGE FORMING DEVICE, PRINT INSTRUCTION DEVICE, IMAGE FORMING SYSTEM, COMPUTER READABLE MEDIUM STORING PROGRAM AND PRINT INSTRUCTION METHOD

(75) Inventor: Daisuke ICHIHASHI, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: Fuji Xerox Co., Ltd., Tokyo (JP)

(21) Appl. No.: 12/335,827

(22) Filed: Dec. 16, 2008

(30) Foreign Application Priority Data
May 13, 2008 (JP) 2008-125854

(51) Int. Cl. G06K 15/00; G06F 3/12

(52) U.S. Cl. 358/1.16; 358/1.15

(57) ABSTRACT

A document processor includes a reception unit that receives document data, the document data being broadcasted to another document processor, a data storage unit that stores the document data received by the reception unit, a document data output unit that outputs the document data stored in the data storage unit, an instruction accepting unit that accepts an instruction to execute output based on the document data stored in the data storage unit, a controller that controls the document data output unit to output the document data stored in the data storage unit upon reception of an output instruction from the instruction accepting unit, and a notifying unit that notifies another document processor which stores the document data being broadcasted to the another document processor of an output executed based on the document data.

### CROSS-REFERENCE TO RELATED APPLICATIONS

This application is based on and claims priority under 35 USC 119 from Japanese Patent Application No. 2008-125854 filed May 13, 2008.

### BACKGROUND

### Technical Field

The present invention relates to a document processor, an image forming device, a print instruction device, an image forming system, a computer readable medium storing program and a print instruction method.

### SUMMARY

According to an aspect of the invention, a document processor includes a reception unit that receives document data, the document data being broadcasted to another document processor, a data storage unit that stores the document data received by the reception unit, a document data output unit that outputs the document data stored in the data storage unit, an instruction accepting unit that accepts an instruction to execute output based on the document data stored in the data storage unit, a controller that controls the document data output unit to output the document data stored in the data storage unit upon reception of an output instruction from the instruction accepting unit, and a notifying unit that notifies another document processor which stores the document data being broadcasted to the another document processor of an output executed based on the document data.

### BRIEF DESCRIPTION OF THE DRAWINGS

An exemplary embodiment of the present invention will be described in detail based on the following figures, wherein:

FIG. 1 is a view showing a structure of an image forming system according to an exemplary embodiment of the present invention;

FIG. 2 is a block diagram showing a hardware structure of the image forming system according to the exemplary embodiment of the present invention;

FIG. 3 is a block diagram showing a function structure of the image forming system according to the exemplary embodiment of the present invention;

FIG. 4 shows an example of an output device selection screen displayed on a display 52 when transmitting print data to a designated image forming device;

FIG. 5 is a sequence chart showing an operation of the image forming system according to the exemplary embodiment of the present invention; and

FIG. 6 shows an exemplary list of the accumulated printing jobs displayed on the screen.

### DETAILED DESCRIPTION

An exemplary embodiment of the present invention will be described in detail referring to the drawings.

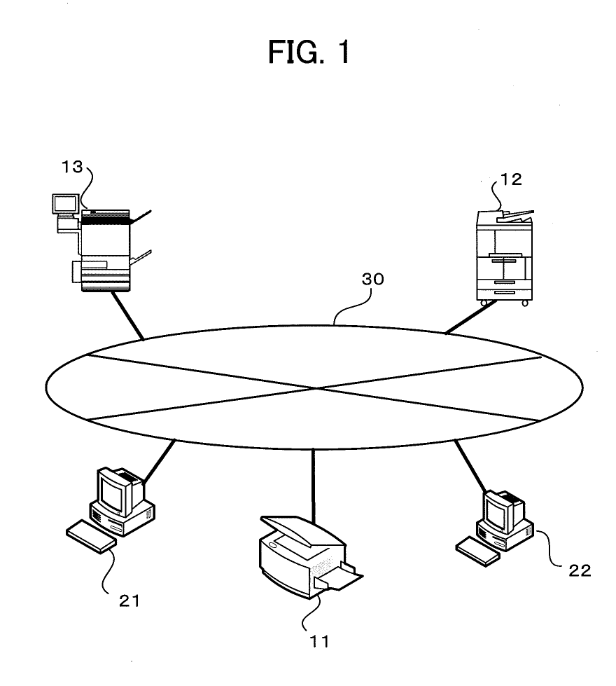

FIG. 1 shows a structure of an image forming system according to an exemplary embodiment of the present invention.

An image forming system according to an exemplary embodiment of the present invention includes image forming devices 11 to 13 mutually connected via a network 30, and terminal devices 21, 22 each serving as a print instruction device capable of sending a printing job to the image forming devices 11 to 13 as shown in FIG. 1. The terminal devices 21, 22 generate print data and transmit it to the image forming devices 11 to 13 via the network 30. Upon reception of the printing data from the terminal devices 21, 22, the image forming devices 11 to 13 output the image corresponding to the print data on a printing sheet. Each of the image forming devices 11 to 13 may be a complex machine which performs plural functions such as printing, scanning, copying and facsimile transmission, or a printer which performs the printing operation only. The print data includes not only image information to be printed but also the information required for the printing, for example, output specification.

A structure of the image forming system according to the exemplary embodiment shown in FIG. 1 is only an example, and not limited to the numbers of the terminal devices and the image forming devices.

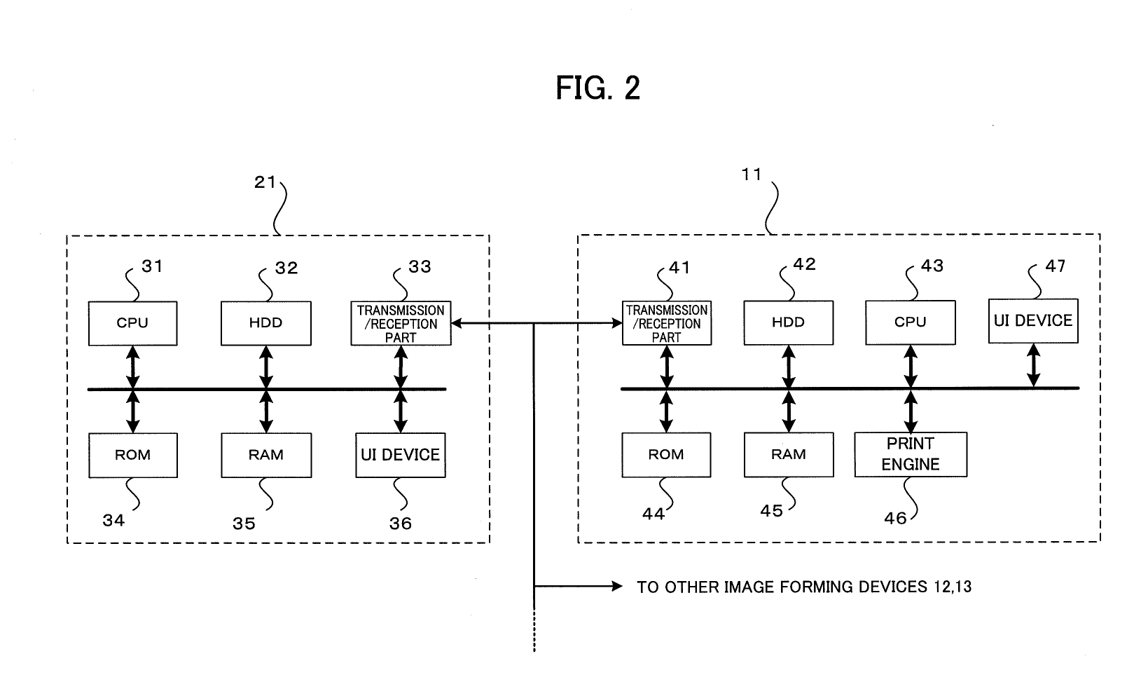

FIG. 2 shows hardware structures of the terminal device 21 and the image forming device 11 in the image forming system according to the exemplary embodiment. FIG. 2 shows only structures of the terminal device 21 and the image forming device 11. However, the terminal device 22 has the same structure as that of the terminal device 21, and the image forming devices 12, 13 each with the same structure as that of the image forming device 11.

The terminal device 21 includes a CPU 31, a hard disk drive (HDD) 32, a transmission/reception part 33, a ROM 34, a RAM 35, and a user interface (UI) 36 including a touch panel, or a liquid crystal display and a keyboard.

The CPU 31 executes a predetermined process based on the control program stored in the ROM 34, the RAM 35, or the HDD 32 to control the operation of the terminal device 21. The transmission/reception part 33 performs data communication with the other device on the network 30.

The image forming device 11 includes a transmission/reception part 41, a HDD 42, a CPU 43, a ROM 44, a RAM 45, a print engine 46, and a UI device 47 as shown in FIG. 2.

The CPU 43 executes a predetermined process based on the control program stored in the ROM 44, the RAM 45 or the HDD 42 to control the operation of the image forming device 11. The transmission/reception part 41 performs data communication with the other devices on the network 30.

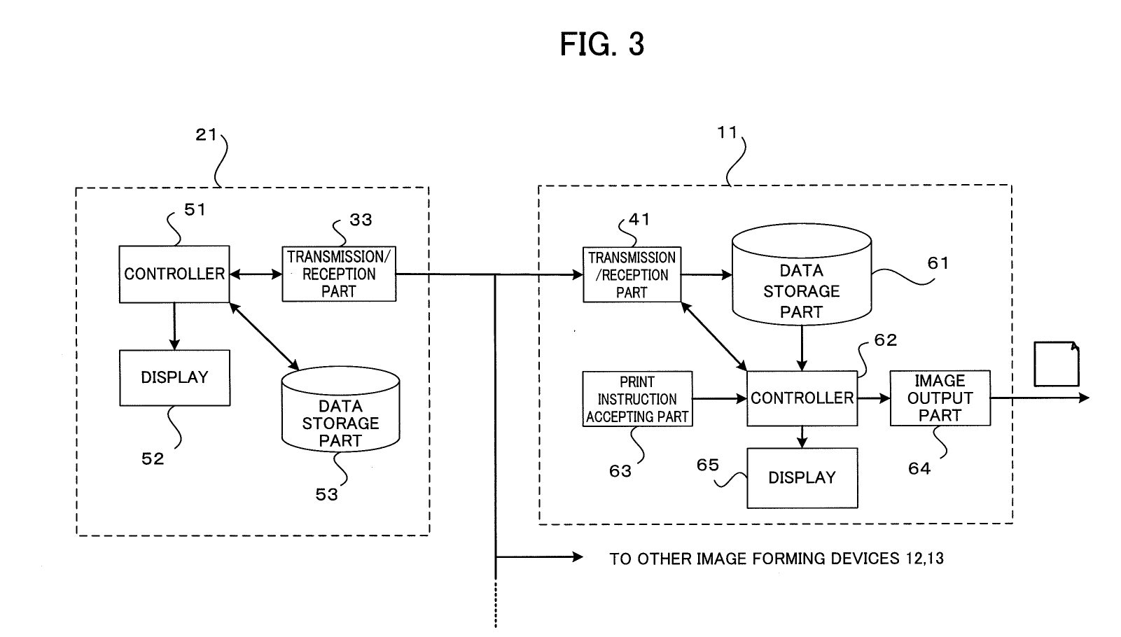

The function structure of the terminal device 21 established by the CPU 31 which executes the control program, and the function structure of the image forming device 11 established by the CPU 43 which executes the control program are shown in FIG. 3.

Referring to FIG. 3, the terminal device 21 includes the transmission/reception part 33, a controller 51, a display 52, and a data storage part 53.

The data storage part 53 stores such data as printing jobs for performing the printing operation.

The controller 51 includes functions to transmit a retrieval request to inquire whether or not the printing job for performing the printing operation is acceptable via the broadcast communication and to transmit the printing job to the image forming device with the address included in the response to the retrieval request.

The broadcast communication is used for data transmission to unspecified addressees, and accordingly, allows data transmission to all the devices on the network even if address information of each of those devices is unknown.

The controller 51 may be structured to transmit the printing job to the plural image forming devices using the communication for transmitting data to the plural addressees, or using the communication for transmitting data to a single addressee.

The display 52 displays various information with respect to the image forming device to which the printing job has been transmitted.

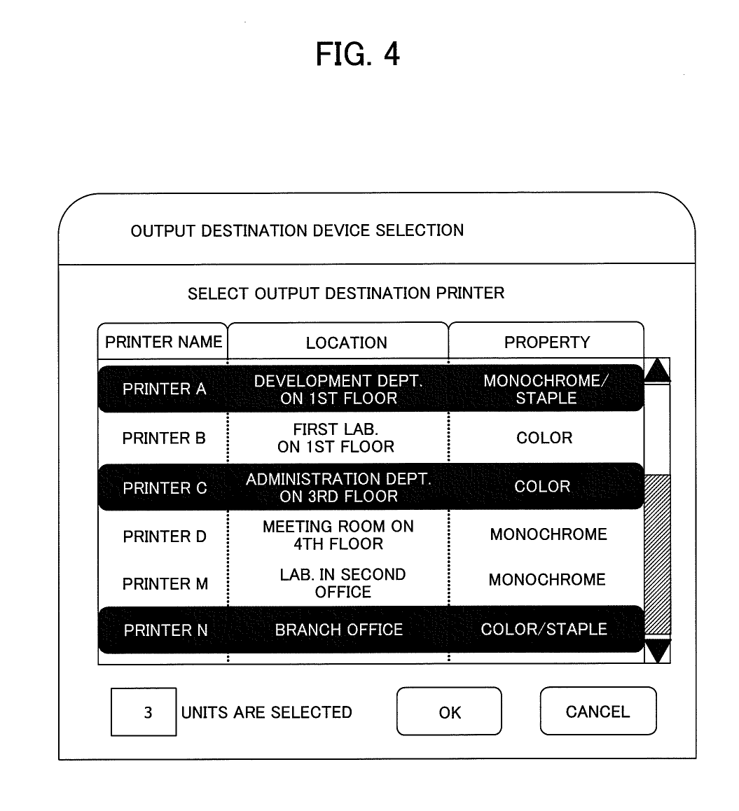

In addition to the use of broadcast communication for transmitting the retrieval request data to specify the image forming device to which the printing job is transmitted based on the obtained response, the user is allowed to directly designate the image forming device to which the printing job is transmitted such that the print data is sent to the designated image forming device. In this case, the screen showing the designated output device is displayed on the display 52 shown in FIG. 4 such that the desired image forming device may be selected from a list of available devices. FIG. 4 shows the printers available for outputting on the exemplary screen. All the printers registered for the terminal device may be displayed, or a group of the printers preliminarily selected from those registered may be displayed as available printers. Alternatively, the printers connected in the same network may only be selected as being available. The available devices may be limited to the printers capable of performing the printing job by the same printer driver.

The communication between the terminal device and the printer is performed using SNMP (Simple Network Management Protocol) to obtain information such as structure and location of the terminal device from the printer for displaying the output device screen. FIG. 4 illustrates an example of the information including the printer names, locations, and structures as properties. The data with respect to the location and structure of each of the printers may be preliminarily stored. Alternatively, the information identified by the user may be displayed. The displayed information with respect to the location and structure of the printer allows the user to easily select the desired printer from the plural printers.

The user is allowed to select the plural printers designated as being available for output arbitrarily from the displayed output device screen. Referring to the exemplary screen shown in FIG. 4, three printers, that is, printers A, C and N are selected. The information with respect to the selected printers such as the printer names will be highlighted. Alternatively, the number of the selected printers may be displayed.

After finishing the selection of the available printers as output destinations, the user depresses the OK button to transmit the printing data to the selected plural printers.

The image forming device 11 includes the transmission/reception part 41, a data storage part 61, a controller 62, a printing instruction accepting part 63, an image output part 64, and a display 65.

The controller 62 receives the retrieval request (inquiry with respect to the acceptance of the printing job) for inquiry whether or not the printing job is acceptable from the terminal device via the broadcast communication for data transmission to unspecified addressees. Upon acceptance of the retrieval request, the controller 62 returns the response which includes its own address information to the terminal device which has transmitted the retrieval request.

The determination with respect to the acceptance of the retrieval request includes the determination whether or not the received retrieval request is acceptable and the determination whether or not it is set to accept the retrieval request.

Each of the image forming devices 11 to 13 may be set to accept or reject the broadcast printing for transmitting the printing job to the plural image forming devices to allow the printing operation. When they are set to accept the broadcast printing, the retrieval request from the terminal device is accepted. When they are set not to accept the broadcast printing, the retrieval request from the terminal device is not accepted.

Even if they are set to accept the retrieval request, when the printing job requires color printing and the image forming device is structured to perform only a monochrome printing, the retrieval request cannot be accepted.

Each of the image forming devices is set to accept the retrieval request, and to return the response to the terminal device which has transmitted the retrieval request notifying the acceptance of the request.

The data storage part 61 stores the printing job sent based on the subject address information. The data storage part 61 stores the printing job which has been sent through the communication for data transmission to the plural addressees, and received by the transmission/reception part 41.

The print instruction accepting part 63 accepts the instruction for printing based on the printing job stored in the data storage part 61 in response to the user's operation of the operation panel.

Upon reception of the print instruction via the print instruction accepting part 63, the controller 62 controls the image output part 64 to output the image based on the printing job stored in the data storage part 61.

The image output part 64 outputs the image based on the printing job instructed to execute the printing on the printing sheet under the control of the controller 62.

The display 65 displays various information with respect to the printing job stored in the data storage part 61 and time when the printing job is stored in the data storage part 61.

When the printing job received by the transmission/reception part 41 includes total copy number information indicating the total number of copies for printing, the controller 62 serves to notify another image forming devices which store the subject printing job of the information that the image based on the printing job has been output via the transmission/reception part 41 subsequent to printing of the print data based on the received print execution instruction. Specifically, the controller 62 has a function to notify another image forming devices which store the printing job of the number of output copies of the image based on the printing job via the transmission/reception part 41. When the sum of the printed copies performed in the image output part 64 and the printed copies based on the information received from the other image forming devices for a certain printing job reaches the total number of copies, the printing job is deleted from the data storage part 61.

The controller 62 may be structured to delete the printing job from the data storage part 61 upon elapse of a predetermined time from reception of the printing job.

An operation of the image forming system according to the exemplary embodiment will be described in detail referring to the drawings.

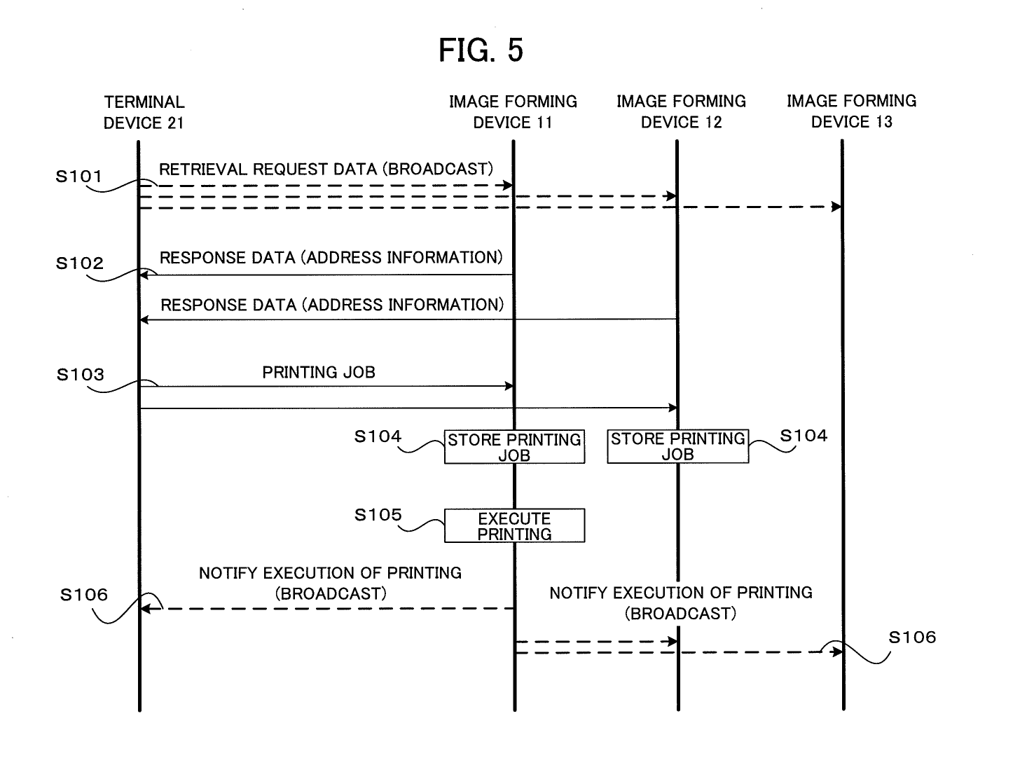

FIG. 5 is a sequence chart representing the operation of the image forming system according to the exemplary embodiment.

In the following description, the terminal device 21 serves to execute the printing job through the broadcast printing. The image forming devices 11 and 12 are set to accept the broadcast printing, and the image forming device 13 is set to reject the broadcast printing.

When executing the printing job, the terminal device 21 delivers the retrieval request data which includes its own address information and the function required for the printing job to be performed (whether the color printing or monochrome printing, the staple is required or not, or two-side printing or one-side printing) to the network 30 via the broadcast communication (step S101).

The retrieval request data from the terminal device 21 are received by the image forming devices 11 to 13. Each of the image forming devices 11 to 13 determines whether the broadcast printing based on the retrieval request data delivered through the broadcast communication is accepted or rejected. In this case, the image forming device 13 is set to reject the broadcast printing. The image forming devices 11 and 12 return the response data which includes address information in accordance with the received retrieval request to the terminal device 21 (step S102).

The terminal device 21 is capable of obtaining the address information of all the image forming devices on the network 30, that is, 11 and 12 capable of performing the printing job from the returned response data. The terminal device 21 then sends the printing job to the address included in the response data (step S103). In the case where the user designates the available output devices as shown in FIG. 4, the printer is clearly identified through the user's selection. As the output port and the address of the destination device corresponding to the respective printers are set, the printing job may be transmitted to the addresses of the plural printers selected by the user.

The image forming devices 11 and 12 store the received printing job (step S104). The image forming devices 11 and 12 are structured to store the printing job but actually do not perform the printing operation. The printing job to be stored includes the information with respect to the total number of printed copies so as to be used for the print management. The information with respect to the total number of printed copies may be extracted from the information transmitted separately from the printing job so as to be used for the print management.

In the case where the user designates the plural printers as output devices without using the broadcast communication as shown in FIG. 4, the information with respect to the plural printers selected from the output devices displayed on the screen shown in FIG. 4 may be transmitted as the one included in the printing job sent from the terminal device, or the individual information related to the printing job. This makes it possible to obtain the other image forming device for receiving the information representing the output states of the respective printers, especially, execution of the printing by the printers, and the number of output copies. In the case where the addressee of the printing job is determined through the broadcast communication, the address information of the image forming device which has sent the response in step S102 may be sent together with the printing job. In the aforementioned case, the inquiry to the addressee through the broadcast communication again is not required for notifying the other image forming devices of the output states and the number of output copies.

When the user actually operates the image forming device 11 or 12 to instruct the print (instruction for starting the print), the image forming device which has received the print instruction starts printing (step S105). FIG. 5 shows the print instruction sent by the user to the image forming device 11. The user is allowed to set the password preliminarily for performing the print instruction so as to execute the printing only when the password is input.

The image forming device 11 which has executed the printing notifies the other image forming devices 12, 13 and the terminal device 21 of execution of printing (step S106). In the case where, in addition to notification by the broadcast communication, the information with respect to the output device to which the printing job has been transmitted is notified to the respective image forming devices together with the printing job, the information with respect to execution of the output based on the information may be notified.

Upon reception of the aforementioned notice, the image forming devices 12 and 13 determine whether or not the number of copies of which printing has actually been executed reaches the designated total number of copies based on the sum of the total number of printed copies received so far and the number of copies printed in the subject image forming device. In other words, the number of printed copies based on the printing job performed by all the image forming devices on the network 30 is calculated. It is then determined whether the calculated number of copies has reached the designated total number of copies. If the sum of the printed copies has reached the total number of copies, the printing job is no longer required. Each of the image forming devices then deletes the printing job.

If the sum of the printed copies has not reached the total number of copies, the printing job is deleted upon elapse of a predetermined time, for example, 12 hours, 24 hours, or one week from the reception or storage of the printing job.

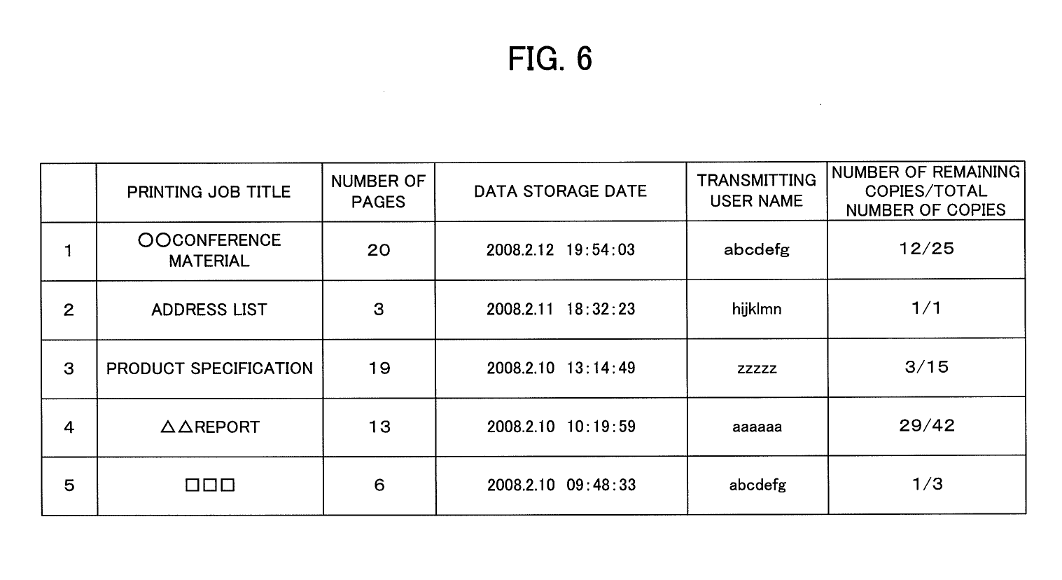

The display 65 of the image forming device 11 may be structured to display the information of the printing jobs stored in the data storage part 61 as shown in FIG. 6. The example shown in FIG. 6 displays the printing job title, page number of pages of the printing job, data storage date, transmitting user name, and number of remained copies/total number of copies. The user is allowed to select the printing job in response to the print execution instruction referring to the display screen.

### [Modification]

In the exemplary embodiment, the retrieval request data is sent from the terminal device 21 to the other devices on the network through the broadcast communication such that the printing job is transmitted only to the image forming device which returns the response data. The printing job may be transmitted directly through the broadcast communication. In the aforementioned case, the image forming device set to accept the broadcast printing stores the received printing job. In the image forming device set to reject the broadcast printing, the received print job may be deleted.

In the exemplary embodiment, the printer driver for displaying the UI screen for receiving the instruction from the user is installed in the print instruction device. However, the present invention is not limited to the aforementioned structure. The print instruction device may be formed as the print server which receives the print data from the other devices that do not have displays to display the UI screen, and transfers such data to the image forming device such as the printer. The aforementioned structure may be applicable to the present invention.

The exemplary embodiment describes the system with respect to the print instruction. The present invention may be applied to a document processor not for printing, for example, a server device, and a document read-out device. In the aforementioned case, the document scanned by the scanner having a data storage unit may be stored in the subject apparatus, and are sent to another apparatus. The other scanner and the document managing apparatus which have received the data may be structured to store the scanned document. The number of outputs such as downloading from the terminal device may be managed while notifying the other devices of such process as downloading.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document processor comprising:
a reception unit that receives document data, the document data being broadcasted to another document processor;
a data storage unit that stores the document data received by the reception unit;
a document data output unit that outputs the document data stored in the data storage unit;
an instruction accepting unit that accepts an instruction to execute output based on the document data stored in the data storage unit;
a controller that controls the document data output unit to output the document data stored in the data storage unit upon reception of an output instruction from the instruction accepting unit; and
a notifying unit that notifies another document processor which stores the document data being broadcasted to the another document processor of an output executed based on the document data.

2. An image forming device comprising:
a reception unit that receives print data, the print data being broadcasted to another image forming device;
a data storage unit that stores the print data received by the reception unit;
an image output unit that outputs the image stored in the data storage unit;
a print instruction accepting unit that accepts an instruction to execute printing based on the print data stored in the data storage unit;
a controller that controls the image output unit to output an image based on the print data stored in the data storage unit upon reception of the print instruction by the print instruction accepting unit; and
a notifying unit that notifies another image forming device which stores the print data being broadcasted to the another image forming device of an output of the image based on the print data.

3. The image forming device according to claim 2, wherein the notifying unit notifies the another image forming device of the number of output copies of the image based on the print data.

4. The image forming device according to claim 2,
wherein the data storage unit stores total copy number information indicating the number of output copies corresponding to the print data; and
the controller deletes the print data from the data storage unit when the number of copies of which image output is executed by the image output unit based on the print data stored in the data storage unit reaches the total copy number information stored in the data storage unit.

5. The image forming device according to claim 4, wherein the reception unit receives a notice that the print data has been output by the another image forming device,
wherein when a sum of the number of copies of which image output is executed by the image output unit and the number of copies output by the another image forming device, which is received by the reception unit, reaches the total number of copies, the controller deletes the print data from the data storage unit.

6. The image forming device according to claim 2, wherein upon elapse of a set time from reception of the print data, the controller deletes the print data from the data storage unit.

7. The image forming device according to claim 2, wherein the controller receives an inquiry with respect to acceptance of the print data from a print instruction device, and sends a response including address information to the print instruction device as a sender of the inquiry, the response including the print instruction device's address information.

8. A print instruction device comprising:
an inquiry transmission unit that transmits an inquiry with respect to acceptance of print data through communication for data transmission to an unspecified addressee; and
a print data transmission unit that transmits the print data to an image forming device with address information included in a response to the inquiry.

9. A print instruction device comprising:
an inquiry transmission unit that transmits an inquiry with respect to acceptance of print data to a plurality of image forming devices; and
a print data transmission unit that transmits the print data to the image forming device with address information included in a response to the inquiry.

10. A print instruction device comprising:
an output destination designation unit that designates a plurality of image forming devices as output devices; and
a print data transmission unit that transmits print data to the image forming device designated by the output destination designation unit.

11. The print instruction device according to claim 8, wherein the print data transmission unit stores the print data in the image forming device, and transmits the print data as an instruction to print the print data in response to a print execution instruction.

12. An image forming system comprising:
a print instruction device including a print data transmission unit that transmits print data to a plurality of image forming devices;
an image forming device including a reception unit that receives print data, the print data being broadcasted to another image forming device; a data storage unit that stores the print data received by the reception unit, an image output unit that outputs the image stored in the data storage unit, a print instruction accepting unit that accepts an instruction to execute printing based on the print data stored in the data storage unit, a controller that controls an image output unit to output the image based on the print data stored in the data storage unit upon acceptance of the print instruction by the print instruction accepting unit, and a notifying unit that notifies another image forming device that stores the print data being broadcasted to the another image forming device of an output of the image based on the print data.

13. The image forming system according to claim 12,
wherein the print instruction device further includes an inquiry transmission unit that transmits an inquiry with respect to acceptance of the print data to the plurality of image forming devices;
the print data transmission unit transmits the print data to the image forming device with address included in a response to the inquiry; and
the controller receives the inquiry from the print instruction device, and sends the response to the print instruction device as a sender of the inquiry, the response including the print instruction device's address information.

14. A computer readable medium storing a program causing a computer to execute a process comprising:
receiving print data, the print data being broadcasted to another image forming device;
storing the print data;
accepting an instruction to execute printing based on the stored print data;
controlling an image output to output an image based on the stored print data upon reception of a print instruction; and
notifying another device that stores the print data being broadcasted to the another image forming device of the image output based on the print data.

15. A computer readable medium storing a program causing a computer to execute a process comprising:
transmitting a retrieval request for inquiring whether or not print data is acceptable through communication for transmitting data to unspecified addressees; and
transmitting the print data to an image forming device with address information included in a response returned to the retrieval request.

16. A print instruction method comprising:
receiving print data, the print data being broadcasted to another image forming device;
storing the print data;
accepting an instruction to execute printing based on the stored print data;
controlling an image output to output an image based on the stored print data upon reception of a print instruction; and
notifying another device that stores the print data being broadcasted to the another image forming device of the image output based on the print data.

17. A print instruction method comprising:
transmitting a retrieval request for inquiring whether or not print data is acceptable through communication for transmitting data to unspecified addressees; and
transmitting the print data to an image forming device with address information included in a response returned to the retrieval request.
